(19) United States
(12) Patent Application Publication
(10) Pub. No.: US 2015/0008873 A1
(43) Pub. Date: Jan. 8, 2015

(54) ELECTRIC VEHICLE CHARGING LOCK

(71) Applicant: David W. Smith, Cedar Park, TX (US)

(72) Inventor: David W. Smith, Cedar Park, TX (US)

(21) Appl. No.: 14/324,165

(22) Filed: Jul. 5, 2014

Related U.S. Application Data
(60) Provisional application No. 61/843,366, filed on Jul. 6, 2013.

(51) Int. Cl. H02J 7/00

(52) U.S. Cl. CPC H02J 7/0042; H02J 7/0052
USPC 320/107; 320/137; 29/876

(57) ABSTRACT

Embodiments disclosed herein describe systems and methods for a charging system with a charging lock to couple a charging converter and a charging handle. In embodiments, the charging converter may also be coupled to a charging port of an electric vehicle. The charging lock may secure the charging converter and the charging handle while the charging converter is within the charging port charging the electric vehicle.

### CROSS-REFERENCE TO RELATED APPLICATIONS

This application claims a benefit of priority under 35 U.S.C. §119 to Provisional Application No. 61/843,366 filed Jul. 6, 2013, which is fully incorporated herein by reference in its entirety.

### BACKGROUND INFORMATION

1. Field of the Disclosure

Examples of the present disclosure are related to techniques for a mechanical lock for a vehicle. More particularly, embodiments relate to a charging lock for a charging converter of an electric vehicle.

2. Background

Due to the increase of prevalence of electric vehicles, there is a growing need for widely distributed and publicly accessible charging stations. Conventionally, charging stations provide power to electric vehicles via a charging handle that outputs power according to standardized power parameters, wherein different types of electric vehicles require different power parameters. Users of electric vehicles use a charging converter to change the power parameters output by the charging handle to power parameters that correspond to their electric vehicle.

However, conventional charging converters do not have a locking mechanism to secure the charging handle to a charging port of the electric vehicle while the charging handle is supplying power to the electric vehicle. Therefore, the charging handle may be decoupled from the charging converter either accidently or intentionally without the owner of the electric vehicle's knowledge while charging the electric vehicle. In circumstances where the charging handle is decoupled from the charging converter and the electric vehicle is not charged, the owner of the electric vehicle may be exposed to inconvenient or dangerous situations if the electric vehicle is not charged as expected.

Accordingly, needs exist for more effective and efficient methods and system for locking a charging converter and a charging cable.

### SUMMARY

Embodiments disclosed herein describe systems and methods for a charging system for vehicles. The charging system may include a charging lock configured to couple a charging converter and a charging handle. The charging lock may secure the charging converter and the charging handle while the charging converter is positioned within a charging port charging an electric vehicle.

In embodiments, a charging converter may include a first side configured to interface with the charging handle. The first side may include a hook receiver interface configured to receive a hook positioned on the charging handle. If the hook of the charging handle is positioned within the hook receiver interface of the charging converter, the charging handle may be coupled to the charging converter. In embodiments, if the hook of the charging handle is positioned within the hook receiver interface, then the hook of the charging handle may be disposed in an engaged position to lock the charging handle and the charging converter.

In embodiments, responsive to a release button disposed on the charging handle being pressed, the hook of the charging handle may be raised away from the hook receiver interface, and the charging converter may be separated from the charging hook to uncouple the charging converter and the charging handle. In embodiments, if the hook of the charging handle is raised away from the hook receiver interface, then the hook may be disposed in a disengaged position.

In embodiments, the charging converter may also include a second side configured to interface with a charging port of an electric vehicle. The second side of the charging converter may include an actuator, depression, notch, locking pin receiver, or other interface configured to couple with a locking pin of the charging port of the electric vehicle. Responsive to the charging converter supplying power to the electric vehicle, a solenoid may actuate the locking pin to be disposed adjacent to the locking pin receiver to secure the charging converter within the charging port. By the locking pin receiver securing the charging converter within the charging port, the charging converter may supply g power to the electric vehicle, while the charging converter may not be removed from the charging port.

In embodiments, the charging lock may be configured to slide over the second side of the charging converter, and the charging lock may be configured to be disposed at a position between the first side of the charging converter and the second side of the charging converter. In embodiments, if the charging lock is slid onto the charging converter and the second side of the charging converter is interfaced with the charging port, then the charging lock may be positioned adjacent to the charging port and cover the hook of the charging handle.

In embodiments, the charging lock may include a plurality of orifices, where each of the orifices may be a different shape, size, and/or height. The different shaped orifices may be shaped to correspond to different sized hooks on charging handles of different charging stations, which may correspond to charging handles for different electric vehicles. Therefore, the charging lock may be utilized on different charging handles regardless of the shape or size of the changing handle and corresponding hook.

In embodiments, at least one of the pluralities of orifices may be configured to slide over the hook of the charging handle that may be engaged with the hook receiver interface of the charging converter. Each of the plurality of orifices may include a top surface that may be configured to be disposed adjacent to the hook, where the top surface may be configured to maintain the hook in the engaged position. In embodiments, the projection may maintain the actuator pin in the engaged position even if the release button of the charging hook is pressed. Accordingly, if the charging converter is engaged with the charging port, then the charging lock may be secured to the charging port, and the charging lock may secure the charging hook in the engaged position.

In embodiments, the actuator pin may be configured to engage with the charging converter responsive to the charging converter being inserted into the charging port. For example, the actuator pin may be engaged with the charging converter upon inserting the charging converter into the charging port before supplying power to the electric vehicle. Furthermore, the actuator pin may be raised, and moved away from the charging converter responsive to the user of the vehicle performing actions to disengage the charging converter from the charging port.

In embodiments, if the user performs actions to disengage the charging converter from the charging port, then the actuator pin of the electric vehicle may be raised away from the charging converter to decouple the charging converter and the charging port. Responsive to the locking pin disengaging with the charging converter, the charging converter, charging handle, and charging lock may be removed from the charging port. Accordingly, when the locking pin disengages with the charging converter, the entire charging system may be removed from the charging port.

In embodiments, responsive to the charging converter being removed from the charging port, the charging lock may slide off the hook of the charging handle and the hook receiving interface. By sliding the charging lock off the hook receiving interface, a user may press the release button of the charging handle, which allows release of the charging converter and charging lock.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts a charging handle coupled to a charging adapter, according to an embodiment.

FIG. 2 depicts a locking system, according to an embodiment.

FIG. 3 depicts a locking system, according to an embodiment.

FIG. 4 depicts a charging lock, according to an embodiment.

FIG. 5 depicts a method secure a charging converter and a charging handle, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

The flowcharts and block diagrams in the flow diagrams illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagrams.

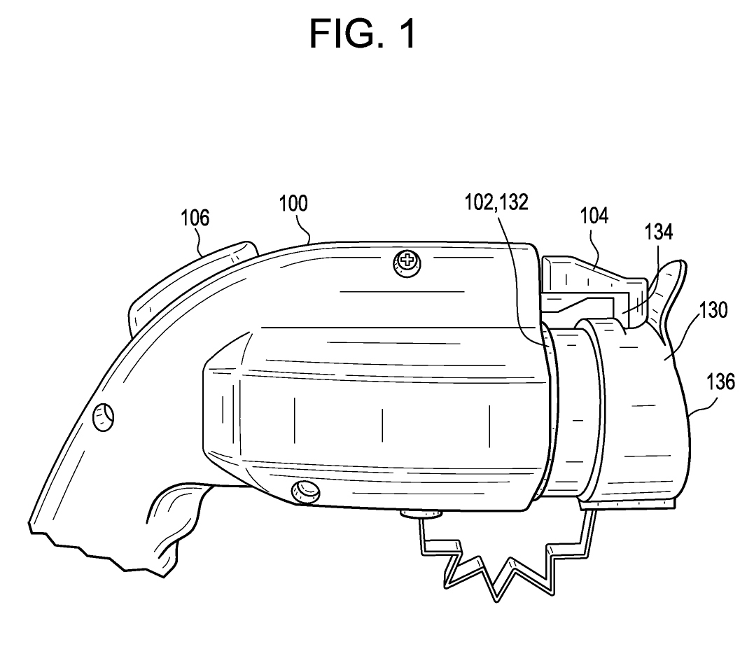

FIG. 1 depicts a charging handle 100 and charging converter 130, according to one embodiment. Charging handle 100 and charging converter 130 may be configured to interface together to supply power to an electric vehicle (not shown).

In embodiments, charging handle 100 may be coupled to a charging station, and be configured to supply power to an electric vehicle. Charging handle 100 may include charging converter interface 102, hook 104, and release button 106.

Charging converter interface 102 may be configured to couple charging handle 100 and charging converter 130, and supply power to charging converter 130. Hook 104 may be a projection configured to be disposed within a depression, notch, charging hook interface 134, or any other coupling interface. Release button 106 may be a configured to move, rise, lift, etc. hook 104 from an engaged position where hook 104 is coupled and/or adjacent to charging hook interface 134, to a disengaged position where hook is not positioned adjacent to charging hook interface 134. In embodiments, if hook 104 is in the disengaged position, then charging handle 100 may be decoupled from charging converter 130, whereas if hook 104 is in the engaged position charging handle 100 may be coupled to charging converter, and charging handle 100 may not be decoupled from charging converter 130.

In embodiments, charging converter 130 may be configured to receive power supplied by charging handle 100, change the power parameters of the supplied power, and transmit power with the changed power parameters to an electric vehicle. Charging converter 130 may include charging converter interface 132, charging hook interface 134, and charging port interface 136.

Charging converter interface 132 may be a shaft positioned on a first side of charging converter 130, and charging port interface 136 may be an interface positioned on a second side of charging converter 130 configured to supply power to an electric vehicle. Charging converter interface 132 may configured to interface with charging handle interface 102 positioned on charging handle 100. Charging converter interface 132 may be configured to change the charging parameters of power supplied by charging handle 100, such that a corresponding electric vehicle may receive power transmitted from charging port interface 136.

Charging hook interface 134 may be a depression, indentation, or notch positioned on a circumference, boundary, or perimeter of charging converter 130. Charging hook interface 134 may be configured to be positioned on a top surface of the perimeter of charging converter 130, such that charging hook interface 134 may receive hook 104. If hook 104 is disposed within or adjacent to charging hook interface 134, then charging converter 130 and charging handle 104 may be coupled together, wherein charging handle 104 may be in the engaged position.

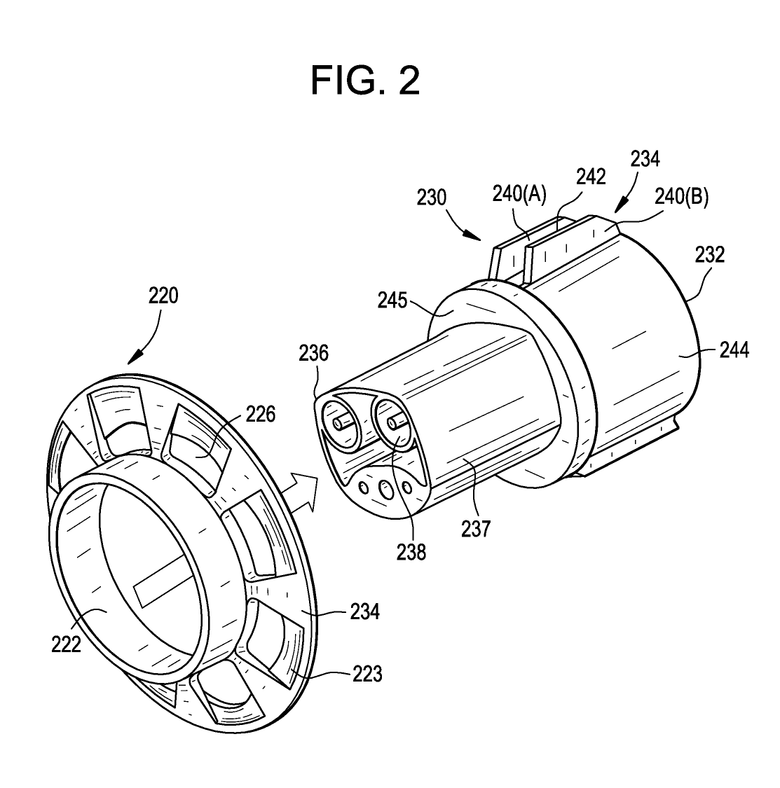

FIG. 2 depicts a charging converter 230 and a charging lock 220, according to an embodiment. One skilled in the art will appreciate that elements of charging converter 230 depicted in FIG. 2, may be the same similar to charging converter 130 as depicted in FIG. 1. Therefore, for the sake of brevity a further description of these elements may be omitted.

Charging converter 230 may include charging handle interface 232, charging hook interface 234, and charging port interface 236.

Charging handle interface 232 may be positioned on a first side of charging converter 230 on a body 244 of charging converter 230, and may be configured to be coupled with a charging handle (not shown). In embodiments, a first face 245 of body 244 may be configured to be adjacent to a charging port of an electric vehicle if charging converter 230 is coupled to or inserted within the charging port of the electric vehicle. In embodiments, body 244 may be substantially cylindrical in shape, however one skilled in the art will understand that body 245 may be any desired shape and/or size.

Charging port interface 236 may be positioned on a second side of charging converter 230, and may be configured to receive charging lock 220. Charging port interface 236 may also be configured to interface with and/or inserted into a charging port of an electric vehicle (not shown). In embodiments, charging port interface 236 may include a shaft 237 configured to extend away from the first side of charging converter 230 to the second side of charging converter 230, wherein shaft 237 may be configured to be inserted into the charging port of the electric vehicle. Shaft 237 may include a plurality of ports 238 configured to interface with the charging port of the electric vehicle. In embodiments, if charging converter 230 is supplying power to the charging port of the electric vehicle, then a locking pin of the charging port may be actuated to lock shaft 237 of charging converter 230 within the charging port. Responsive to receiving a locking pin command from the electric vehicle and/or a key fob, the locking pin may be moved away from charging converter 230, and charging converter 230 may be removed from the charging port.

In embodiments, charging hook interface 234 may include a plurality of projections 240(a) and 240(b) and notch 242. Projections 240(a) and 240(b) may be configured to perpendicularly extend away from charging converter 230 to define a chamber, space, or compartment to secure a hook of a charging handle, wherein the chamber may secure the hook of the charging handle if the charging handle is in the engaged position. Notch 242 may be a projection that extends away from or into charging converter 230, wherein notch 242 may be configured to be disposed between projections 240(a) and 240(b). In embodiments, notch 242 may be configured to receive the hook of the charging handle, and couple and/or lock the charging handle to the charging converter if the charging handle is in the engaged positioned. Responsive to the release button of the charging handle being pressed, the hook may be moved away from notch 242, and the charging handle may be decoupled from charging converter 230.

Charging lock 220 may be a device configured to be positioned adjacent to a charging port of an electric vehicle and slide over charging hook interface 234, wherein charging lock 220 may be configured to cover a hook interfaced with charging hook interface 234. Responsive to charging lock 220 being disposed over the hook interface with charging hook interface 234, the hook may not be raised to be in the disengaged position when charging lock 220. In embodiments, charging lock 220 may include an inner perimeter 222, projection 223, outer perimeter 224, and at least one orifice 226.

Inner perimeter 222 may be shaped and/or sized to have a circumference that is greater than shaft 237 of charging converter 230, such that charging lock 220 may be slid over shaft 237. Inner perimeter 222 may be shaped to encompass body 244, such that inner perimeter 222 may cover at least a portion of a perimeter of body 244. In embodiments, inner perimeter 222 may be shaped to be positioned adjacent around an entire perimeter of body 244 to secure charging lock 220 to charging converter 230.

Projection 223 may extend from inner perimeter 222 to outer perimeter 224. In embodiments, projection 223 may be substantially circular in shape. Projection 223 may include a plurality of orifices, slots, or openings 226. The plurality of orifices 226 may extend from a position of along inner perimeter 222 towards outer perimeter 224, and the heights of each of the plurality of orifices 226 may be different. In implementations, the height of each of the orifices 226 may correspond to a height of different sized hooks on different charging handles, such that a top surface of at least one of plurality of orifices 226 may be configured to be positioned adjacent to a top surface of the hook if the hook is in the engaged position. If one of the pluralities of orifices 226 is positioned adjacent to the charging handle's hook, the charging handle may be coupled and secured to charging converter 230.

In embodiments, responsive to a release button being pressed on the charging handle, a top surface of the orifice 226 positioned adjacent to the hook may not allow the hook to rise, and the hook may be maintained in the engaged position. To decouple charging converter 230, charging lock 220, and the charging handle it may be desired or required to disengage the locking pin between charging converter 230 and the charging port of the electric vehicle, and remove charging converter 230, charging lock 220 and the charging handle away from the charging port. Charging lock 220 may then be removed from a position covering the hook and moved away from charging converter 230. Then, a release button on the charging handle may be pressed to change the hook of the charging handle from being in an engaged position to a disengaged position.

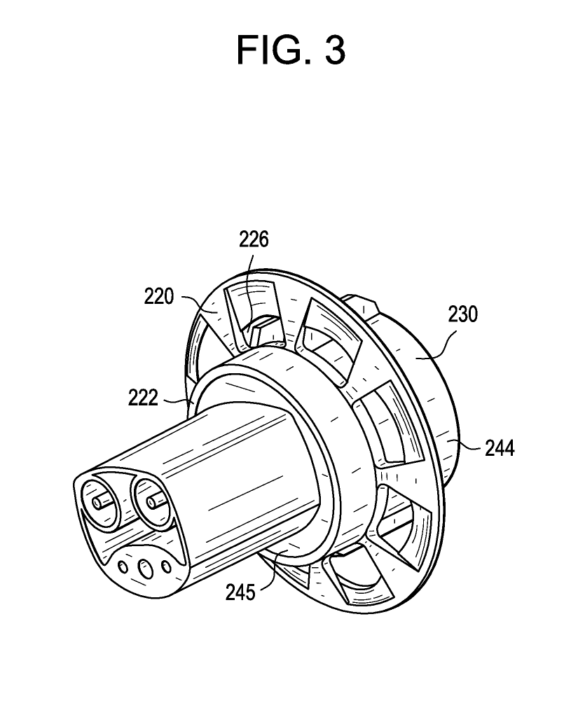

FIG. 3 depicts an embodiment of charging converter 230 coupled with charging lock 220. In an embodiment as depicted in FIG. 3, a first of the plurality of orifices 226 may be positioned to cover a hook of the charging handle, and secure a charging handle in the engaged position. When charging converter 230 is inserted into an electric vehicle, inner perimeter 222 of charging lock 220 may be positioned adjacent to body 244 of charging converter 220 and face 245 of body 244 may be positioned adjacent to the charging port of the electric vehicle. Therefore, if charging converter 230 is interfaced with the charging port of the electric vehicle, then the first of the plurality of orifices 226 may not be moved to a position that is not adjacent to the hook of the charging handle, and the charging handle will be locked in the engaged position via charging lock 220.

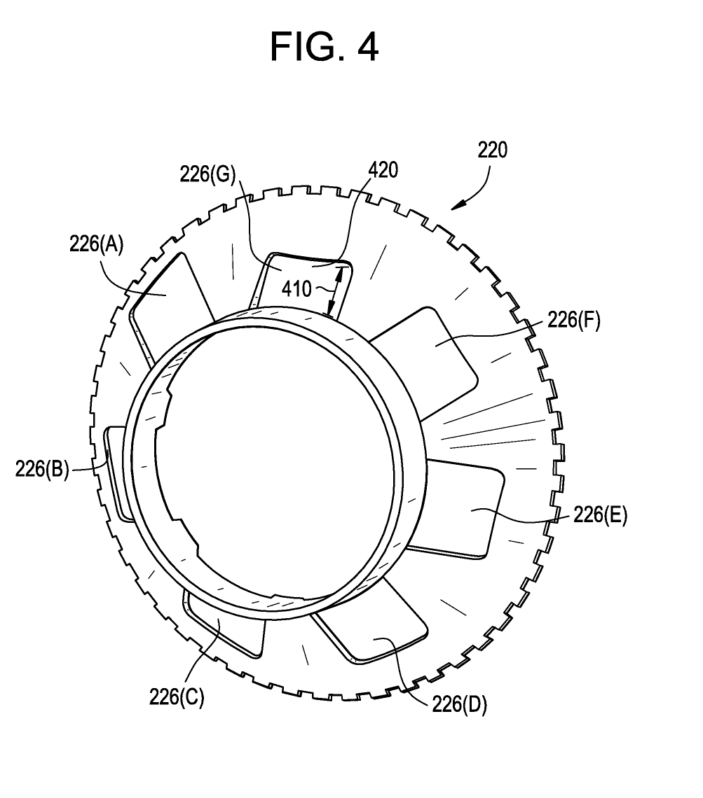

FIG. 4 depicts an embodiment of charging lock 220. As depicted in FIG. 4 charging lock 220 includes a plurality of orifices 226(A)-(G). Each of the plurality of orifices 226(A)-(G) may have a different height 410. Responsive to charging lock 220 being positioned over the body of the charging converter and the charging handle being in the engaged position with the charging converter, charging lock 220 may be rotated to select a first of the plurality of orifices 226(A)-(G). The selected one of the plurality of orifices 226(A)-(G) may have a height 410 that corresponds to the height of the hook of the charging handle, such that a top surface 420 of the selected one of the plurality of orifices may be slid over the hook and be positioned adjacent to a top surface of the hook.

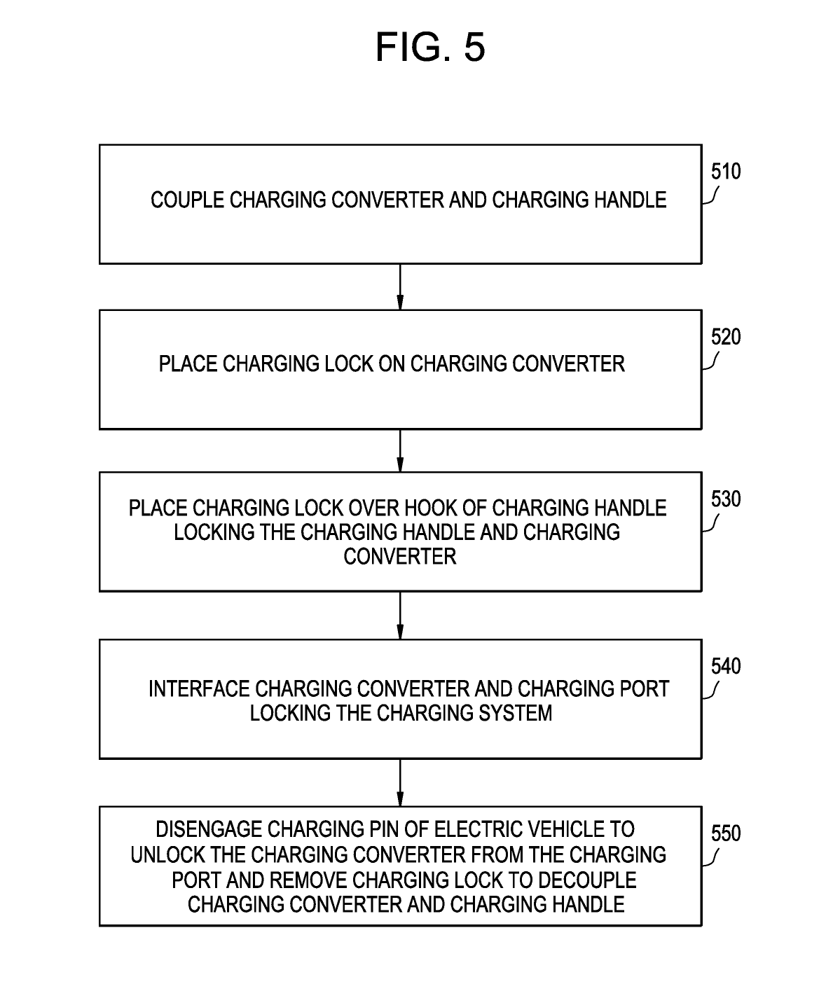

FIG. 5 illustrates a method 500 for locking a charging converter and a charging handle. The operations of method 500 presented below are intended to be illustrative. In some embodiments, method 500 may be accomplished with one or more additional operations not described, and/or without one or more of the operations discussed. Additionally, the order in which the operations of method 500 are illustrated in FIG. 5 and described below is not intended to be limiting.

At operation 510, a charging converter may be coupled with a charging handle of a charging station. In an implementation, a hook of the charging handle may be positioned to be interfaced with a charging hook interface on the charging converter, such that the hook is in an engaged position with the charging hook interface.

At operation 520, a charging lock may be positioned over a first end of the charging converter.

At operation 530, the charging lock may be rotated to select an orifice on the charging lock that corresponds to a height of the locked hook. The orifice that corresponds to the height of the hook may have a top surface that is positioned at the same height of the top surface of the hook. In embodiments, the charging lock may then be pressed in a direction towards the second end of the charging converter to place the top surface of the selected orifice over the top surface of the hook.

At operation 540, the first end of the charging converter may be interfaced with a charging port of the electric vehicle, and a face of the charging lock may be positioned adjacent to the charging port, such that the selected orifice of the charging lock may not be removed from a position covering the top surface of the hook. Responsive to interfacing the first end of the charging handle and the charging port of the electric vehicle, the electric vehicle may actuate a charging pin to lock the charging converter in place.

At operation 550, the charging port may receive a command to disengage the charging pin to unlock the charging converter from the charging port. The charging converter, charging lock, and charging handle may be moved away from the charging port of the electric vehicle. The charging lock may then be moved in a direction towards the first end of converter, and the top surface of the selected orifice may no longer be positioned adjacent to the top surface of the hook of the charging handle. A release button of the charging handle may be depressed to move the hook from an engaged position to a disengaged position, and the charging handle and the charging converter may be decoupled.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A locking system for a vehicle comprising:
a charging converter including a first end, a second end and a charging hook interface, the first end being configured to interface with a charging port of an electric vehicle, the second end being configured to interface with a charging handle of a charging station, the charging hook interface being configured to couple with a hook of the charging handle; and
a charging lock including an orifice with a top surface, the top surface of the orifice being configured to be positioned adjacent to a top surface of the hook when the charging converter and the charging handle are coupled.

2. The locking system of claim 1, wherein responsive to the top surface of the orifice being positioned adjacent to the top surface of the hook, the hook couples the charging converter and the charging handle.

3. The locking system of claim 2, wherein responsive to the top surface of the orifice being positioned adjacent to the top surface of the hook, the top surface of the orifice does not allow the hook to be raised away from the charging hook interface.

4. The locking system of claim 2, wherein when the first end of the charging converter is interfaced with the charging port, the top surface of the hook is positioned adjacent to the top surface of the orifice.

5. The locking system of claim 2, wherein the orifice includes a plurality of orifices, wherein each of the plurality of orifices has a different height.

6. The locking system of claim 1, wherein the charging converter includes a shaft, the shaft extending away from a body of the charging converter, the shaft being configured to be inserted into the charging port, and a first face of the body being configured to be positioned adjacent to the charging port when the shaft is inserted into the charging port.

7. The locking system of claim 6, wherein the charging lock is configured to be positioned adjacent to the body of the charging converter when the charging converter and the charging handle are coupled.

8. The locking system of claim 1, wherein the charging converter is configured to supply power to the charging port.

9. The locking system of claim 1, further comprising:
an actuator positioned within the charging port, the actuator configured to secure the charging handle of the charging station within the charging port.

10. A method for a vehicle comprising:
coupling a first end of a charging converter to a charging port of an electric vehicle;
coupling a second end of the charging converter with a charging handle of a charging station;
coupling a hook of the charging handle with a charging hook interface positioned on the charging converter; and
positioning a top surface of an orifice within a charging lock adjacent to a top surface of the hook.

11. The method of claim 10, further comprising:
coupling the charging converter and the charging handle via the hook responsive to the top surface of the orifice being positioned adjacent to the top surface of the hook.

12. The method of claim 11, wherein responsive to the top surface of the orifice being positioned adjacent to the top surface of the hook, the top surface of the orifice does not allow the hook to be raised away from the charging hook interface.

13. The method of claim 11, further comprising:
positioning the top surface of the hook adjacent to the top surface of the orifice wherein when the first side of the charging converter is interfaced with the charging port.

14. The method of claim 11, wherein the orifice includes a plurality of orifices, wherein each of the plurality of orifices has a different height.

15. The method of claim 10, further comprising:
inserting a shaft of the charging converter into the charging port, wherein the shaft extends away from a body of the charging converter;
positioning a first face of the body adjacent to the charging port when the shaft is inserted into the charging port.

16. The method of claim 15, further comprising:
positioning the charging lock adjacent to the body of the charging converter when the charging converter and the charging handle are coupled.

17. The method of claim 10, further comprising:
supplying power from the charging converter to the charging port.

18. The method of claim 10, further comprising:
securing the charging handle of the charging station within the charging port via an actuator positioned within the charging port.

19. A locking system for a vehicle, the locking system comprising:
a charging converter configured to be inserted into a charging port of a vehicle;
a hook configured to be coupled to the charging converter responsive to the charging port being inserted into the vehicle; and
a charging lock configured to be positioned over the hook while the charging port is inserted into the vehicle, wherein the charging lock limits the movement of the hook.

20. The locking system for the vehicle of claim 19, further comprising:
a shaft positioned on a first side of the charging converter, the shaft being configured to be inserted into the charging port of the vehicle, wherein the charging lock is configured to slide over the shaft before inserting the shaft into the charging port.
